(19) United States
(12) Patent Application Publication
(10) Pub. No.: US 2007/0004859 A1
(43) Pub. Date: Jan. 4, 2007

(54) Priming agent for separating papers and films

(76) Inventors: Andreas Bacher, Burghausen (DE); Karl Ernst Ficker, Altotting (DE); Theo Mayer, Julbach (DE); Hans Lautenschlager, Haiming (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/557,751

(22) PCT Filed: May 13, 2004
(86) PCT No.: PCT/EP04/05155

§ 371 Date: Nov. 18, 2005

(30) Foreign Application Priority Data
May 22, 2003 (DE) 10323204.4

(51) Int. Cl. C08F 116/06

(52) U.S. Cl. 525/56

(57) ABSTRACT

Release papers and films are coated with a primer containing a silane-modified polyvinyl alcohol and an H-siloxane prior to coating with an abhesive silicone release coating.

The invention relates to a primer (or priming agent) for release (or separating) papers and release films, based on silane-functional polyvinyl alcohols in combination with reactive silicone polymers.

To produce release papers having dehesive properties with respect to adhesives the paper backings are furnished with a layer of silicone. To enhance the silicone layer, and particularly in order to prevent penetration into the backing material during coating, the backing paper is provided with a prime coat before the silicone layer is applied.

From DE-A 3727078 it is known to use solutions of metal complexes and film formers such as polyvinyl alcohol as prime coats. In DE-A 4425737 a coat of waterglass is formed as a prime coat on the paper. In the process of EP-A 396789 the prime coat applied is a suspension comprising film formers, white pigment, and noble metal catalyst. DE-A 19512663 recommends a pigment coat with aluminum hydroxide. EP-A 399079 applies for the prime coat organosilanes or organosiloxanes, alone or in a mixture with binders such as polyvinyl alcohol, for priming. U.S. Pat. No. 5,358,977 describes the use of crosslinkable aromatics or aliphatics as primers. JP-A 58/214596 describes paper coated with silane-modified polyvinyl alcohol and possessing suitability for producing release paper.

Disadvantages attending the prime coats employed to date include their frequently unsatisfactory binding to the abhesive silicone layer and a consequent extended heating time for the crosslinking silicone.

The object which therefore existed was to provide a primer which eliminates the abovementioned disadvantages and is suitable particularly for producing release papers with a fast-crosslinking, abhesive silicone coating.

The invention provides a primer composition for release papers and release films, comprising

I) at least one silane-containing polyvinyl alcohol based on fully or partly hydrolyzed vinyl ester copolymers having a degree of hydrolysis of 75 to 100 mol %, obtainable by free-radically polymerizing

a) one or more vinyl esters of unbranched or branched alkylcarboxylic acids having 1 to 18 carbon atoms, of which a fraction of 0 to 30 mol %, based on total polymer, are one or more 1-alkylvinyl esters having alkyl radicals having 1 to 6 carbon atoms and of carboxylic acids having 1 to 6 carbon atoms,

b) 0.01 to 10 mol % of one or more silane-containing, ethylenically unsaturated monomers, and if desired

c) further comonomers copolymerizable therewith, and hydrolyzing the resultant polymers, and

II) at least one reactive silicone from the group of the H-siloxanes.

Suitable silane-containing polyvinyl alcohols are fully or partly hydrolyzed vinyl ester polymers having a degree of hydrolysis of 75 to 100 mol % and a fraction of silane-containing comonomer units of 0.01 to 10 mol %. The fully hydrolyzed vinyl ester polymers have a degree of hydrolysis of preferably 97.5 to 100 mol %, more preferably 98 to 99.5 mol %. The partly hydrolyzed polyvinyl esters have a degree of hydrolysis of preferably 80 to 95 mol %, more preferably 86 to 90 mol %. The Höppler viscosity (in accordance with DIN 53015, as a 4% strength by weight aqueous solution) serves as a measure of the molecular weight and of the degree of polymerization of the partly or fully hydrolyzed, silanized vinyl ester polymers, and is preferably from 2 to 50 mPas.

Suitable vinyl esters are vinyl esters of unbranched or branched carboxylic acids having 1 to 18 carbon atoms. Preferred vinyl esters are vinyl acetate, vinyl propionate, vinyl butyrate, vinyl 2-ethylhexanoate, vinyl laurate, vinyl pivalate, and vinyl esters of α-branched monocarboxylic acids having 5 to 13 carbon atoms, examples being VeoVa9^{R} or VeoVa10^{R} (trade names of Shell). Particular preference is given to vinyl acetate.

Preferred 1-alkylvinyl esters having alkyl radicals having 1 to 6 carbon atoms and of carboxylic acids having 1 to 6 carbon atoms are 1-methylvinyl acetate, 1-ethylvinyl acetate, and 1-propylvinyl acetate. In one preferred embodiment 1 to 30 mol % of 1-alkylvinyl esters, more preferably 1-methylvinyl acetate, are copolymerized.

Suitable ethylenically unsaturated, silane-containing monomers b) are, for example, ethylenically unsaturated silicon compounds of the general formula (I) R¹SiR²₀₋₂(OR³)₁₋₃, where R¹ has the definition CH₂═CR⁴—(CH₂)₀₋₃ or CH₂═CR⁴CO₂(CH₂)₁₋₃, R² has the definition C₁ to C₃ alkyl radical, preferably methyl or ethyl, C₁ to C₃ alkoxy radical, preferably methoxy or ethoxy, or halogen, preferably Cl or Br, R³ is an unbranched or branched, unsubstituted or substituted alkyl radical having 1 to 12 carbon atoms, preferably 1 to 3 carbon atoms, or an acyl radical having 2 to 12 carbon atoms, it being possible for R³ to be interrupted if desired by an ether group, and R⁴ is H or CH₃.

Suitable ethylenically unsaturated, silane-containing monomers b) are also meth(acrylamides) contained silane groups, of the general formula (II) CH₂═CR⁵—CO—NR⁶—R⁷—SiR⁸ₘ—(R⁹)₃₋ₘ, where m=0 to 2, R⁵ is either H or a methyl group, R⁶ is H or an alkyl group having 1 to 5 carbon atoms; R⁷ is an alkylene group having 1 to 5 carbon atoms or a divalent organic group in which the carbon chain is interrupted by an oxygen or nitrogen atom, R⁸ is an alkyl group having 1 to 5 carbon atoms, R⁹ is an alkoxy group having 1 to 40 carbon atoms, which may be substituted by further heterocycles. In monomers where there are 2 or more groups R⁵ or R⁹ these groups may be identical or different.

Examples of (meth)acrylamido-alkylsilanes of this kind are as follows: 3-(meth)acrylamido-propyltrimethoxysilanes, 3-(meth)-acrylamido-propyltriethoxysilanes, 3-(meth)acrylamido-propyltri(β-methoxy-ethoxy)silanes, 2-(meth)acrylamido-2-methylpropyltrimethoxy-silanes, 2-(meth)acrylamido-2-methylethyltrimethoxysilanes, N-(2-(meth)acrylamido-ethyl)amino-propyltrimethoxysilanes, 3-(meth)acrylamido-propyltriacetoxysilanes, 2-(meth)acrylamido-ethyl-trimethoxysilanes, 1-(meth)acrylamido-methyltrimethoxy-silanes, 3-(meth)acrylamido-propylmethyldimethoxy-silanes, 3-(meth)acryl-amido-propyldimethylmethoxy-silanes, 3-(N-methyl-(meth)acryl-amido)-propyl-trimethoxysilanes, 3-((meth)acrylamido-methoxy)-3-hydroxypropyltrimethoxysilanes, 3-((meth)acrylamido-methoxy)-propyltrimethoxysilanes, N,N-dimethyl-N-trimethoxysilylpropyl-3-(meth)acrylamido-propylammonium chloride, and N—N-dimethyl-N-trimethoxysilylpropyl-2-(meth)acrylamido-2-methylpropylammonium chloride.

Preferred ethylenically unsaturated, silane-containing monomers b) are γ-acryloyloxy- and γ-methacryloyloxypropyltri(alkoxy)silanes, α-methacryl-oyloxymethyltri(alkoxy)silanes, γ-methacryloyl-oxypropylmethyldi(alkoxy)silanes; vinylsilanes such as vinylalkyldi(alkoxy)silanes and vinyltri(alkoxy)-silanes, in which alkoxy groups used may be, for example, methoxy, ethoxy, methoxyethylene, ethoxyethylene, methoxypropylene glycol ether and/or ethoxypropylene glycol ether radicals. Examples of preferred silane-containing monomers are 3-methacryloyloxypropyltrimethoxysilane, 3-methacryloyl-oxypropylmethyldimethoxysilane, vinyltrimethoxysilane, vinylmethyldimethoxysilane, vinyltriethoxysilane, vinylmethyldiethoxysilane, vinyltripropoxysilane, vinyltriisopropoxysilane, vinyltris-(1-methoxy)-isopropoxysilane, vinyltributoxysilane, vinyltri-acetoxysilane, methacryloyloxymethyltrimethoxysilane, 3-methacryloyloxypropyl-tris(2-methoxyethoxy)silane, vinyltrichlorosilane, vinylmethyldichlorosilane, vinyltris-(2-methoxyethoxy)silane, trisacetoxyvinyl-silane, allylvinyltrimethoxysilane, allyltriacetoxy-silane, vinyldimethylmethoxysilane, vinyldimethyl-ethoxysilane, vinylmethyldiacetoxysilane, vinyl-dimethylacetoxysilane, vinylisobutyldimethoxysilane, vinyltriisopropyloxysilane, vinyltributoxysilane, vinyltrihexyloxysilane, vinylmethoxydihexoxysilane, vinyltrioctyloxysilane, vinyldimethoxyoctyloxysilane, vinylmethoxydioctyloxysilane, vinylmethoxydilauryloxy-silane, vinyldimethoxyl-auryloxysilane, and also polyethylene glycol-modified vinylsilanes.

Maximum preference as ethylenically unsaturated, silane-containing monomers b) is given to vinyltrimethoxysilane, vinylmethyldimethoxysilane, vinyltriethoxysilane, vinylmethyldiethoxysilane, vinyltris-(1-methoxy)-isopropoxysilane, methacryloyloxypropyl-tris(2-methoxyethoxy)silane, 3-methacryloyloxypropyltrimethoxysilane, 3-methacryloyloxypropyl-methyldimethoxysilane, and methacryloyloxymethyltrimethoxysilane, and also mixtures thereof.

The silanes b) are preferably copolymerized in an amount of 0.01 to 10.0 mol %, more preferably 0.01 to 2.0 mol %.

Besides the silane-containing monomers it is also possible for one or more further comonomers c) to be present, in a fraction of preferably 0.1 to 25 mol %. By way of example, ethylene, propylene, isobutylene, butadiene, isoprene, chloroprene, styrene, α-methyl-styrene, vinyl chloride, vinylidene chloride, vinyl fluoride, acrylonitrile, methacrylonitrile; alkyl vinyl ethers such as ethyl vinyl ether, n-butyl vinyl ether, isobutyl vinyl ether, tert-butyl vinyl ether, cyclohexyl vinyl ether, octadecyl vinyl ether, hydroxybutyl vinyl ether, and cyclohexanedimethanol monovinyl ether; vinyl methyl ketone, N-vinylformamide, N-vinyl-N-methylacetamide, N-vinylcaprolactam, N-vinyl-pyrrolidone, and N-vinylimidazole. Also suitable are acrylic acid and methacrylic acid and their esters and amides, such as methyl (meth)acrylate, ethyl (meth)acrylate, n-butyl (meth)acrylate, isobutyl (meth)acrylate, ethylhexyl (meth)acrylate, benzyl (meth)acrylate, 2-hydroxyethyl (meth)acrylate, hydroxypropyl (meth)acrylate, n-hexyl (meth)acrylate, isooctyl (meth)acrylate, isodecyl (meth)acrylate, lauryl (meth)acrylate, methoxyethyl (meth)acrylate, phenoxyethyl (meth)acrylate, isobornyl (meth)acrylate, stearyl (meth)acrylate, cyclohexyl (meth)acrylate, α-chloroacrylic esters, and α-cyanoacrylic esters. Further examples are vinylcarbazole, vinylidene cyanide, vinyl esters, acrylic anhydride, maleic anhydride, maleic and fumaric esters, sulfonic acid-modified monomers such as 2-acrylamido-2-methyl-propanesulfonic acid and the alkali metal salts thereof, cationic monomers such as trimethyl-3-(1-(meth)acrylamido-1,1-dimethylpropyl)ammonium chloride, trimethyl-3-(1-(meth)acrylamidopropyl)ammonium chloride, 1-vinyl-2-methylimidazole, and the quaternized compounds thereof.

The silane-containing vinyl ester polymers can be prepared in a known way by means of polymerization; preferably by bulk polymerization, emulsion polymerization, suspension polymerization, or by polymerization in organic solvents, more preferably in alcoholic solution. The molecular weight can be adjusted in a manner known to the skilled worker, by polymerizing in the presence of molecular weight regulators. The silane-containing vinyl ester polymers are hydrolyzed in a manner known per se; for example, by the belt method or compounder method or in a stirred tank, in the alkaline or acidic range, with addition of acid or base. After the end of the hydrolysis the solvent is distilled off and the silane-containing polyvinyl alcohol is obtained as powder. The aqueous solution of the silane-containing polyvinyl alcohols may where appropriate also be dried by nozzle spraying, and the silane-containing polyvinyl alcohol recovered as powder. The preparation of silane-containing polyvinyl alcohols in powder form is described in detail, for example, in DE-A 10232666. Common drying methods are fluid-bed drying, thin-film drying, freeze drying, and spray drying.

Reactive silicones from the group of the H-siloxanes are preferably linear, cyclic or branched organopolysiloxanes composed of units of the general formula (III) RₑH_{f}SiO_{(4-e-f)/2}, where e is 0, 1, 2 or 3, f is 0, 1 or 2, and the sum of e+f is ≦3, with the proviso that there are on average at least 2 Si-bonded hydrogen atoms, and R is a monovalent, SiC-bonded, unsubstituted or substituted hydrocarbon radical having 1 to 18 carbon atoms.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl, and methyl-cyclohexyl radicals; alkenyl radicals, such as the vinyl, 5-hexenyl, cyclohexenyl, 1-propenyl, allyl, 3-butenyl, and 4-pentenyl radical; alkynyl radicals, such as the ethynyl, propargyl, and 1-propynyl radical; aryl radicals, such as the phenyl, naphthyl, anthryl, and phenanthryl radical; alkaryl radicals, such as o-, m-, and p-tolyl radicals, xylyl radicals, and ethylphenyl radicals; and aralkyl radicals, such as the benzyl radical, the α- and the β-phenylethyl radical.

Examples of substituted radicals R are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m-, and p-chlorophenyl radical, and all radicals mentioned for R above, which can be substituted preferably by mercapto groups, epoxy-functional groups, carboxyl groups, keto groups, enamine groups, amino groups, aminoethylamino groups, isocyanato groups, aryloxy groups, acryloyloxy groups, methacryloyloxy groups, hydroxyl groups, and halogen groups.

The radical R is preferably a monovalent hydrocarbon radical having 1 to 6 carbon atoms, the methyl radical being particularly preferred.

Preference is given to organopolysiloxanes of the general formula (IV) HₕR₃₋ₕSiO(SiR₂O)ₒ(SiRHO)ₚSiR₃₋ₕHₕ, where R has the definition indicated for it above, h is 0, 1 or 2, o is 0 or an integer from 1 to 1500, and p is 0 or an integer from 1 to 200, with the proviso that the organopolysiloxanes of the formula (IV) contain on average at least 2 Si-bonded hydrogen atoms. The formula (IV) should be understood such that o units (SiR₂O)- and p units -(SiRHO)- units may be distributed arbitrarily, for example, blockwise or at random, within the organopolysiloxane molecule.

Examples of such organopolysiloxanes are, in particular, copolymers composed of dimethylhydro-siloxane, methylhydrosiloxane, dimethylsiloxane and trimethylsiloxane units, copolymers composed of trimethylsiloxane, dimethylhydrosiloxane, and methylhydrosiloxane units, copolymers composed of trimethyl-siloxane, dimethylsiloxane, and methylhydrosiloxane units, copolymers composed of methylhydrosiloxane and trimethylsiloxane units, copolymers composed of methylhydrosiloxane, diphenylsiloxane, and trimethyl-siloxane units, copolymers composed of methylhydrosiloxane, dimethylhydrosiloxane, and diphenyl-siloxane units, copolymers composed of methylhydrosiloxane, phenylmethylsiloxane, trimethyl-siloxane and/or dimethylhydrosiloxane units, copolymers composed of methylhydrosiloxane, dimethylsiloxane, diphenyl-siloxane, trimethylsiloxane and/or dimethylhydro-siloxane units, and copolymers composed of dimethylhydrosiloxane, trimethylsiloxane, phenylhydrosiloxane, dimethylsiloxane and/or phenylmethylsiloxane units.

The organopolysiloxanes possess an average viscosity of preferably 10 to 100000 mPa.s at 25° C., preferably 15 to 1000 mPa.s at 25° C.

The organopolysiloxanes are obtained by methods known to the skilled worker and are converted into the form of aqueous emulsions.

The ratio of the silane-containing polyvinyl alcohol component (I) to the silicone component (II) (solids/solids) is from 99:1 to 1:99, preferably 99:1 to 50:50, more preferably 99:1 to 70:30. The primer composition may if desired also include further binders and additives. Typical further additives and binders are as follows: pigments, polyvinyl alcohols, carboxymethylcelluloses, starch, starch derivatives, alginates, proteins, aqueous polymer dispersions based on (meth)acrylic acid, (meth)acrylic esters, acrylonitrile, vinyl acetate, butadiene, styrene, and also plasticizers such as ethylene glycols, glycerol, and catalysts.

The primer composition may be applied in any way which is suitable and common knowledge for producing coatings from liquid materials; for example, by dipping, spreading, pouring, spraying, rolling, printing, using for example an offset gravure coating apparatus, blade or knife coating, or by means of an airbrush. Application takes place preferably in an amount of 0.5 to 5.0 g/m², more preferably 1.5 to 3.0 g/m².

The processes and formulas for the release coating of release papers and release films are known to the skilled worker. Suitable backings are papers, especially base papers, and also films such as polyethylene films, PET films, nonwovens, wovens, and base crepe release stock. After the backing material has been primed the silicone coat is applied using the stated application methods. Suitable silicone polymers having dehesive properties are known to the skilled worker and encompass, for example, catenary dimethylpolysiloxanes having terminal hydroxyl groups, which on exposure to elevated temperature and in the presence of organotin salt catalysts are condensed with silicic esters, or are obtained by the addition crosslinking route, by reacting catenary polymers having vinyl end groups with hydropolysiloxanes with exposure to temperature in the presence of platinum catalysts. The formulas for the silicone coat may where appropriate also include further additives, examples being film-forming assistants such as polyvinyl alcohol, carboxymethylcelluloses, or plasticizers such as ethylene glycol and glycerol.

### EXAMPLES

Preparation of the silane-modified polyvinyl alcohol: A thermostatted laboratory apparatus with 2.5 liters' capacity was charged under nitrogen with 375.5 g of methanol, 2.47 g of vinyltriethoxysilane, 24.7 g of isopropenyl acetate and 309.1 g of vinyl acetate. With stirring, 785 mg of tert-butyl perpivalate were added and the batch was heated to 60° C. and maintained at 60° C. during the reaction.

15 minutes after the beginning of reaction a further 1.34 g of tert-butyl perpivalate were added. After a further 30 minutes a mixture of 7.2 g of vinyltri-ethoxysilane, 72 g of isopropenyl acetate and 900 g of vinyl acetate was metered in over a period of 165 minutes at a rate of 383.7 ml/h. At the same time a further 785 mg of tert-butyl perpivalate were added. 75 minutes and 105 minutes after the beginning of reaction portions of 448 mg, after 135 minutes 224 mg, and after 165 minutes, 195 minutes, and 230 minutes after the start of reaction portions of 113 mg of tert-butyl perpivalate were added.

270 minutes after the beginning of reaction 312 g of methanol were added to the batch. After a reaction time of 420 minutes the batch was cooled and hydrolyzed.

In a laboratory reactor with 2.5 liters' capacity 265 g of the methanolic polyvinyl alcohol solution were diluted with a further 1250 g of methanol. The solution was heated to 30° C. and admixed with methanolic NaOH (13.8 g of NaOH, 46% strength in water, dissolved in 113 g of methanol).

The solution became increasingly cloudy. During the gel phase the stirrer was set to a higher speed in order to comminute the gel. Following the gel phase reaction was allowed to continue for 2 hours more, after which the product was neutralized with acetic acid and the solid formed was isolated by filtration, washed, and dried. This gave a fully hydrolyzed polyvinyl alcohol having a Höppler viscosity of 6 mPas (4% strength in water).

### Example 1

48.4 g of modified polyvinyl alcohol prepared above were added slowly at 90° C. to 351.6 g of water, giving a 12.1% strength aqueous solution.

350 g of the aqueous modified polyvinyl alcohol solution (12.1%; pH 9.5) were charged to a 400-ml glass beaker. With the Ultra Turrax stirrer running, 4.71 g of an H-containing polysiloxane (Mn 2400 g/mol; Silicone V24) were added slowly dropwise over 30 seconds. The speed of the Ultra Turrax stirrer was increased for 1 to 2 minutes until a complete emulsion formed, with a temperature of 40° C. to 50° C. The ratio of the modified polyvinyl alcohol to the silicone is 90:10 (solids/solids).

### Example 2

The same as Example 1, but using in lieu of 4.71 g of an H-containing polysiloxane (Mn 2400 g/mol; Silicone V24) the same amount of a vinyl- and H-containing polysiloxane (Mn 5200 g/mol; Silicone HV70).

### Comparative Example 1

Only a 12.1% strength by weight aqueous solution of the above-prepared modified polyvinyl alcohol, without a silicone fraction, was used.

### Comparative Example 2

Only a 12.1% strength by weight aqueous solution of a non-silane-modified polyvinyl alcohol, having a Höppler viscosity of 6 mPas (4% strength in water), was used.

Preparation of the Paper:

The primers from the inventive and comparative examples were each applied by means of a laboratory sizing press to a base paper and dried accordingly (coating 1.5 g/m² to 3 g/m²). Atop the paper thus primed there was applied a release coat composed of 100 parts by weight of a vinyl-terminated polysiloxane (Dehesive 920), 2.4 parts by weight of an H-containing siloxane crosslinker (Vernetzer V24) and 1 part by weight of Pt catalyst (Katalysator OL), and the coated paper was heated at 150° C. for 7 seconds.

Description of the Test Methods:

Migration (MI):

A test adhesive tape was applied to the freshly siliconized face, in each case after the curing time (CT) described in the table, and then peeled off again.

The adhesive strip was folded together so that the adhesive surfaces were in contact. Then the ends were pulled apart (loop test). If the layers adhering to one another have good adhesion, this suggests good adhesion of the silicone coat on the substrate. Both tests are scored in school grades from 1 to 6:1=very good, 6=very poor.

Ruboff (RO):

In each case after the curing time (CT) described in the table, the siliconized surface is rubbed once, vigorously, with the finger, and this area is viewed under obliquely incident light. If there are differences in lightness, or streaks, in this area, the adhesion of the silicone product is not optimum. In addition, the silicone coat is rubbed strongly with the finger a number of times and the amount of abraded particles is observed. Both tests are scored in school grades from 1 to 6.

Test results:

| | | | | | Comp. | Comp. | Comp. | Comp. |
|---|---|---|---|---|---|---|---|---|
| | Ex. 1 | Ex. 1 | Ex. 2 | Ex. 2 | ex. 1 | ex. 1 | ex. 2 | ex. 2 |
| CT | MI | RO | MI | RO | MI | RO | MI | RO |
| 5 s | 1 | 3 | 1 | 1 | 4 | 5 | 6 | 6 |
| 6 s | 1 | 1 | | | 2 | 2 | 6 | 6 |
| 7 s | | | | | 1 | 1 | 4 | 5 |
| 8 s | | | | | | | 4 | 4 |

The results show that with the primers of the invention outstanding binding is obtained after just a short crosslinking time. With silane-containing polyvinyl alcohols alone (Comp. ex. 1) this is obtained only after a substantially longer crosslinking time.

1-12. (canceled)

13. A primer composition for release papers and release films, comprising
a) at least one silane-containing polyvinyl alcohol comprising fully or partly hydrolyzed vinyl ester copolymers having a degree of hydrolysis of 75 to 100 mol %, obtained by free-radically polymerizing
a)i) one or more vinyl esters of unbranched or branched alkylcarboxylic acids having 1 to 18 carbon atoms, of which a fraction of 1 to 30 mol %, based on total polymer, comprise one or more 1-alkylvinyl esters of carboxylic acids having 1 to 6 carbon atoms, the alkyl radicals of the 1-alkylvinyl esters having 1 to 6 carbon atoms,
a)ii) 0.01 to 10 mol % of one or more silane-containing, ethylenically unsaturated monomers, and optionally,
a)iii) further comonomers copolymerizable therewith, and hydrolyzing the resultant polymers, and
b) at least one reactive H-siloxane.

14. The primer of claim 13, wherein the silane-containing polyvinyl alcohol is obtained by hydrolyzing a vinyl acetate copolymer.

15. The primer of claim 13, wherein one or more 1-alkylvinyl esters selected from the group consisting of 1-methylvinyl acetate, 1-ethylvinyl acetate, and 1-propylvinyl acetate are copolymerized.

16. The primer of claim 13, wherein the silane-containing polyvinyl alcohol is obtained by copolymerizing one or more ethylenically unsaturated, silane-containing monomers selected from the group consisting of ethylenically unsaturated silicon compounds of the formula (I) R¹SiR²₀₋₂(OR³)₁₋₃, where R¹ is CH₂═CR⁴—(CH₂)₀₋₃ or CH₂═CR⁴CO₂(CH₂)₁₋₃, R² is a C₁ to C₃ alkyl radical, C₁ to C₃ alkoxy radical, or halogen, R³ is an unbranched or branched, unsubstituted or substituted alkyl radical having 1 to 12 carbon atoms, or an acyl radical having 2 to 12 carbon atoms, R³ optionally being interrupted by an ether group, and R⁴ is H or CH₃, and
meth(acrylamides) containing silane groups, of the formula (II) CH₂═CR⁵—CO—NR⁶—R⁷—SiR⁸ₘ—(R⁹)₃₋ₘ, where m=0 to 2, R⁵ is H or a methyl group, R⁶ is H or an alkyl group having 1 to 5 carbon atoms; R⁷ is an alkylene group having 1 to 5 carbon atoms or a divalent organic group in which the carbon chain is interrupted by an oxygen or nitrogen atom, R⁸ is an alkyl group having 1 to 5 carbon atoms, R⁹ is an alkoxy group having 1 to 40 carbon atoms, which may be substituted by further heteroatoms.

17. The primer of claim 16, wherein the silane-containing polyvinyl alcohol is obtained by copolymerizing one or more ethylenically unsaturated, silane-containing monomers selected from the group consisting of γ-acryloyloxy- and γ-methacryloyloxypropyltri(alkoxy)silanes, α-meth-acryloyloxymethyltri(alkoxy)silanes, γ-methacryl-oyloxypropylmethyldi(alkoxy)silanes, vinylalkyldi-(alkoxy)silanes and vinyltri(alkoxy)silanes.

18. The primer of claim 17, wherein the alkoxy group(s) are selected from the group consisting of methoxy, ethoxy, methoxyethylene, ethoxyethylene, methoxypropylene glycol ether and ethoxypropylene glycol ether radicals.

19. The primer of claim 13, wherein 0.01 to 2.0 mol % of ethylenically unsaturated, silane-containing monomers are copolymerized.

20. The primer of claim 13, wherein at least one reactive silicone component b) is selected from the group consisting of linear, cyclic or branched organopolysiloxanes comprising units of the formula (III) RₑH_{f}SiO_{(4-e-f)/2}, where e is 0, 1, 2 or 3, f is 0, 1 or 2, and the sum of e+f is ≦3, with the proviso that there are on average at least 2 Si-bonded hydrogen atoms, and R is a monovalent, SiC-bonded, unsubstituted or substituted hydrocarbon radical having 1 to 18 carbon atoms.

21. The primer of claim 20, wherein at least one reactive silicone component b) is selected from the group consisting of organopolysiloxanes of the formula (IV) HₕR₃₋ₕSiO(SiR₂O)ₒ(SiRHO)ₚSiR₃₋ₕHₕ, where h is 0, 1 or 2, o is 0 or an integer from 1 to 1500, and p is 0 or an integer from 1 to 200, with the proviso that the organopolysiloxanes of the formula (IV) contain on average at least 2 Si-bonded hydrogen atoms.

22. The primer of claim 13, wherein the ratio of the silane-containing polyvinyl alcohol component (a) to the silicone component (b) (solids/solids) is from 99:1 to 1:99.

23. In a process for the silicone coating of a paper or film substrate to form a release coating wherein a primer is used, the improvement comprising coating the substrate with a primer of claim 13 prior to coating with a silicone abhesive coating.

24. A release paper or film, prepared by the process of claim 23.

25. A release film or paper comprising
a) a substrate comprising at least one of a film or a paper;
b) coated onto said substrate a primer of claim 13;
c) coated onto said primer a silicone abhesive coating.
